(19) United States
(12) Patent Application Publication
(10) Pub. No.: US 2004/0075436 A1
(43) Pub. Date: Apr. 22, 2004

(54) Calculating method for inductance in a semiconductor integrated circuit

(75) Inventors: Atsushi Kurokawa, Yokohama-shi (JP); Hiroo Masuda, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Semiconductor Technology Academic Research Center

(21) Appl. No.: 10/421,005

(22) Filed: Apr. 21, 2003

(30) Foreign Application Priority Data
Oct. 21, 2002 (JP) 2002-306031

(51) Int. Cl. G01V 3/00

(52) U.S. Cl. 324/318

(57) ABSTRACT

There is disclosed a calculating method for an inductance in a semiconductor integrated circuit, comprising first recognizing connection of a wiring and structure of the wiring from a process structure and layout data of the wiring with respect to an object in a designated region. Next, the wiring is divided into a plurality of segments based on predetermined places to be divided and designated wiring length with respect to the connection and structure of the wiring. Next, a relation between the divided two segments is obtained. Next, an equation of a self inductance approximated with a geometric mean distance (GMD) of a wiring section is used to calculate partial self inductances of the respective segments based on the relation between the two segments. Moreover, an equation of a mutual inductance is used to calculate a partial mutual inductance between the two segments.

### CROSS-REFERENCE TO RELATED APPLICATIONS

This application is based upon and claims the benefit of priority from the prior Japanese Patent Application No. 2002-306031, filed Oct. 21, 2002, the entire contents of which are incorporated herein by reference.

### BACKGROUND OF THE INVENTION

1. Field of the Invention

The present invention relates to a calculating method, particularly to a high-speed extraction method of an on-chip inductance in a semiconductor integrated circuit.

2. Description of the Related Art

In general, in design of LSI: (1) a parasitic inductance of a wiring is not considered; or (2) the parasitic inductance is obtained using an apparatus called a 3D field solver to divide a wiring section into a large number of filaments with respect to some of wirings which are likely to be influenced by the inductance.

A concrete technique of the 3D field solver is disclosed, for example, in the following document:

M. Kamon, M. J. Tsuk, and J. White, “FASTHENRY”: a multiple accelerated 3D inductance extraction program,” IEEE Journal on Microwave Theory & Techniques, pp. 1750-1758, September 1994, and Raphael version 2000.4, Synopsys Corporation.

A reason for (1) is that for a wiring delay in a wiring structure and operation frequency in a related-art process, resistance R and capacity C have heretofore been dominant, a degree of influence of the inductance onto propagation delay of a signal is 1% or less, and this is very small. However, around a 0.13 μm process, the influence of the inductance onto the propagation delay cannot be ignored. A difference between RC delay by the resistance R and capacity C and LRC delay in which an inductance L is also considered sometimes exceeds several percentages in a worst case.

To solve the problem, it has become necessary to perform precise analysis using the 3D field solver described in (2) as circumstances demand.

A calculating method for the inductance by the above-described 3D field solver is high in accuracy because a skin effect and a proximity effect are also considered. On the other hand, the inductance cannot be extracted at high speed. This disadvantage becomes remarkable in the current large-scaled LSI exceeding several millions of transistors. Moreover, there is also a method of obtaining only a self inductance of a loop in order to reduce a processing rate. However, this method has a very bad accuracy, and cannot be used in actual design.

Therefore, an object of the present invention is to provide a calculating method for an inductance to keep a practical accuracy of the inductance which is a wiring parasitic element of a large-scaled LSI, while the inductance can be calculated at a high speed.

Another object of the present invention is to provide a calculating method for an inductance using a selected optimum equation suitable for a demanded accuracy by a structure of wiring, so that the inductance can be calculated at a higher rate and with a high accuracy.

### BRIEF SUMMARY OF THE INVENTION

To achieve the above-described objects, according to a first aspect of the present invention, there is provided a calculating method for an inductance in a semiconductor integrated circuit, comprising: a step of recognizing connection of a wiring and structure of the wiring from a process structure and layout data of the wiring with respect to an object in a designated region; a step of dividing the wiring into a plurality of segments based on predetermined places to be divided and designated wiring length with respect to the recognized connection and structure of the wiring; a step of obtaining a relation between the divided two segments; and a step of calculating partial self inductances of the respective segments based on the obtained relation between the two segments using an equation of a self inductance approximated with a geometric mean distance (GMD) of a wiring section and calculating a partial mutual inductance between the two segments using an equation of a mutual inductance.

A second aspect of the present invention relates to the calculating method for the inductance according to the first aspect of the present invention. In the method, the step of calculating the partial mutual inductance comprises: regarding the wiring as a linear wiring whose section is infinitely small; calculating the partial mutual inductance with respect to the wiring within a designated interval using an equation of an exact parallel wiring between linear conductors, when two linear wirings are in a mutually parallel relation; calculating the partial mutual inductance using an exact equation of an oblique wiring between the linear conductors when an angle between two linear wirings is larger than 0 degree and smaller than 90 degrees; and setting the partial mutual inductance to 0 to obtain the inductance, when the two linear wirings form 90 degrees.

A third aspect of the present invention relates to the calculating method for the inductance according to the first aspect of the present invention. In the method, the step of calculating the partial mutual inductance comprises: regarding the wiring as a linear wiring whose section is infinitely small; comparing data with data obtained beforehand by an electromagnetic analysis tool for each process or using a conventional structure to select an equation whose error is within a predetermined range from an exact equation between the linear wirings, a plurality of equations obtained by approximating the exact equation between the linear wirings with Taylor expansion, a plurality of equations derived by applying a geometric mean distance to the wiring which is a bunch of a plurality of linear wirings and whose section has a thickness of 0 and a finite width after the Taylor expansion of the exact equation between the linear wirings, and an equation in which the wiring section is exactly considered with respect to the wiring within a designated interval, based on structure parameters of the width, interval, and length of the wiring, when two linear wirings have a mutually parallel relation; and next calculating the partial mutual inductance using an equation whose calculation cost is minimum from the selected equation.

A fourth aspect of the present invention relates to the calculating method for the inductance according to the first aspect of the present invention. The method further comprises: also obtaining the partial self inductance and the partial mutual inductance using an electromagnetic analysis tool, when the wiring has a wiring structure largely influenced by a skin effect and a proximity effect.

A fifth aspect of the present invention relates to the calculating method for the inductance according to the first aspect of the present invention. The method further comprises: obtaining a table of data obtained by an electromagnetic analysis tool beforehand and also obtaining the partial self inductance and the partial mutual inductance using the table, when the wiring has a wiring structure largely influenced by a skin effect and a proximity effect.

A sixth aspect of the present invention relates to the calculating method for the inductance according to the first aspect of the present invention. The method further comprises: obtaining a polynomial equation of data obtained by an electromagnetic analysis tool beforehand and also obtaining the partial self inductance and the partial mutual inductance using the polynomial equation, when the wiring has a wiring structure largely influenced by a skin effect and a proximity effect.

A seventh aspect of the present invention relates to the calculating method for the inductance according to the first aspect of the present invention. The method further comprises: obtaining the inductance using a power supply wiring and a ground wiring as objects whose inductances are calculated; and excluding the other wirings.

An eighth aspect of the present invention relates to the calculating method for the inductance according to the first aspect of the present invention. The method further comprises: obtaining the inductance using a power supply wiring, a ground wiring, and a clock wiring, or a bus wiring as objects whose inductances are calculated; and excluding the other wirings.

A ninth aspect of the present invention relates to the calculating method for the inductance according to the first aspect of the present invention. The method further comprises: obtaining the inductance using a power supply wiring, a ground wiring, and a signal wiring whose length is not less than a designated length as objects whose inductances are calculated; and excluding the other wirings.

A tenth aspect of the present invention relates to the calculating method for the inductance according to the first aspect of the present invention. The method further comprises: a step of calculating a loop inductance using a power supply wiring whose current return path is dominant; and a step of calculating delay from a resistance, the loop inductance, and a capacity to search a critical net influenced by the inductance.

An eleventh aspect of the present invention relates to the calculating method for the inductance according to the first aspect of the present invention. The method further comprises: a step of constituting the segment by a π-type or T-type equivalent circuit including the calculated partial self inductance and/or partial mutual inductance, a resistance, and a capacity; and a step of removing a place whose partial self inductance or partial mutual inductance is small to perform a static or dynamic timing analysis.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a whole design flow in an ASIC/SOC design;

FIG. 2 shows a flow indicating details of extraction (step S3 of FIG. 1) of a parasitic inductance necessary for timing analysis in layout design according to an embodiment of the present invention;

FIGS. 3A to 3C are explanatory views of a concrete example in which connection and structure of a wiring are extracted from layout data;

FIGS. 4A, 4B are explanatory views of a concrete example in which wiring data is divided into segments;

FIG. 5 is a diagram showing relations among the respective segments with respect to the wiring structures shown in FIGS. 4A, 4B;

FIG. 6 shows a flow indicating details for setting conditions in performing a step of extracting the connection and structure of the wiring from the layout data (step S12 of FIG. 2);

FIG. 7 shows a flow indicating details for setting the conditions in performing a step of extracting a partial self inductance of the segment (step S15 of FIG. 2);

FIG. 8 shows a flow indicating details for setting the conditions in performing a step of extracting a partial mutual inductance between the segments (step S15 of FIG. 2);

FIG. 9 is a diagram showing two wirings i, j which have sectional areas Sᵢ, Sⱼ;

FIG. 10 is a diagram showing one wiring which has a width w, thickness t, and length l;

FIG. 11 is an explanatory view showing that a wiring section is approximated with a point of center of the section as a linear wiring and a partial mutual inductance of two wirings (l is the length of the wiring, and r denotes a distance between the wirings) is obtained;

FIG. 12 is a diagram showing two linear wirings which extend in parallel with each other;

FIG. 13 is a diagram showing two linear wirings which have a mutually oblique relation;

FIG. 14 is a diagram showing one example of the wiring whose section has a thickness of 0 and a finite width;

FIG. 15 is a structure diagram in calculating a mutual inductance in which the wiring section is exactly considered;

FIG. 16 is a diagram showing two conductors having a parallel equal length for use in verifying accuracy of an equation according to the present embodiment;

FIG. 17 is a table showing calculation costs of the respective equations (ratio of a processing time, when equation (11) is regarded as 1);

FIG. 18 is a diagram showing an optimum equation obtained by a procedure of the present embodiment by a map;

FIG. 19 is a diagram showing standards extracted from FIG. 18 by which the respective equations are approximately used by each structure;

FIG. 20 is a diagram showing an accuracy distribution, when a 3D field solver is regarded as the standard;

FIG. 21 is a diagram showing a result of comparison of an optimum equation by the structure shown in FIG. 18 and applied to an LSI wiring of an actual 0.13 μm process with an exact equation in which a section is considered with respect to the processing rate;

FIGS. 22A to 22C are explanatory views showing an application example in which an equivalent circuit is prepared in step S16 based on a self inductance L extracted in step S15 of FIG. 2; and

FIGS. 23A and 23B are diagrams showing an example in which the equivalent circuit is constituted based on a calculated mutual inductance M.

### DETAILED DESCRIPTION OF THE INVENTION

First, an outline of the present invention will be described. According to the present invention, in design of a semiconductor integrated circuit, there is provided a method comprising: recognizing connection of a wiring and an XYZ coordinate of start and end points of the wiring, a wiring layer, a wiring width, and a wiring thickness from a process structure and layout data of the wiring with respect to an object in a designated region; dividing the wiring in a place in which the wiring is bent, an intersection, a via, and a wiring exceeding a designated maximum wiring length; recognizing the length of the divided wiring; judging whether two segments are parallel to each other or cross at right angles to each other and recognizing an interval between the segments in the segments having a length which is not less than a designated length; calculating a partial self inductance of the segment using an equation of a self inductance approximated with a geometric mean distance (GMD) of a wiring section; and calculating a partial mutual inductance between two segments whose interval indicates a value not less than a designated value using an equation of a mutual inductance. Here, the GMD is defined by a mean distance of naturalized logarithm.

In this manner, in the present invention, the equation is used to calculate the inductance which is a wiring parasitic element of a large-scaled LSI. Therefore, while an actual accuracy is kept, a high-speed processing time can be realized.

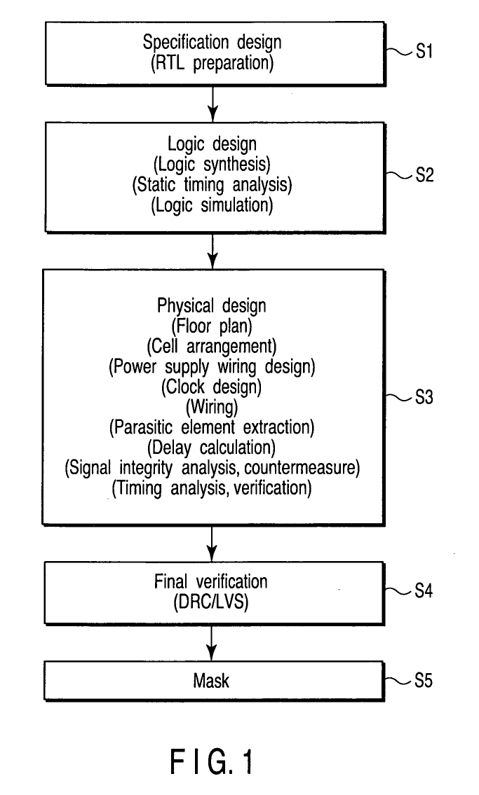

An embodiment of the present invention will be described hereinafter in detail with reference to the drawings. FIG. 1 shows a whole design flow in an ASIC/SOC design. First, specification design including preparation of RTL is performed (step S1). Next, logic design including operations such as logic synthesis, static timing analysis, and logic simulation is performed (step S2). Next, physical design is performed including operations such as floor plan, cell arrangement, power supply wiring design, clock design, wiring, extraction of the parasitic element (parasitic inductance here), delay calculation, signal integrity analysis and countermeasure, and timing analysis and verification (step S3). Next, final verification (DRC/LVS) (step S4) is performed. Finally, mask processing (step S5) is performed.

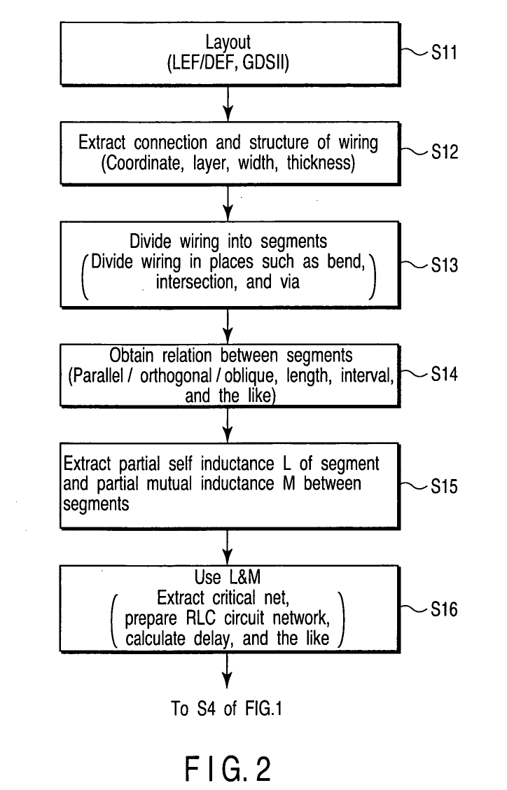

FIG. 2 shows a flow indicating details of extraction (step S3 of FIG. 1) of a parasitic inductance necessary for timing analysis in layout design according to an embodiment of the present invention. First, layout processing (LEF/DEF, GDSII) (step S11) is performed. Next, the connection and structure (such as coordinate, layer, width, thickness) of the wiring are extracted from the layout data (step S12).

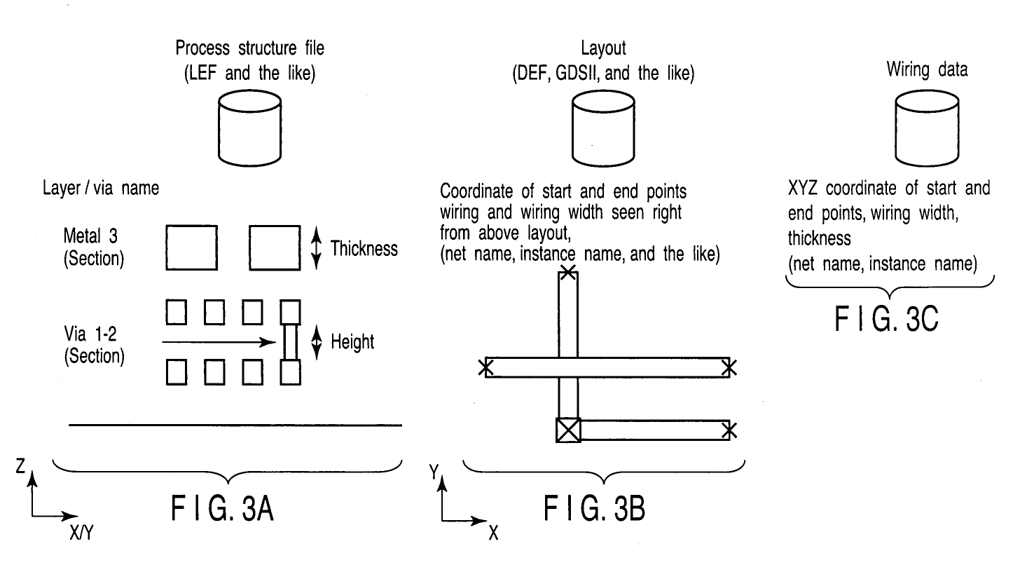

FIGS. 3A to 3C are explanatory views of a concrete example in which connection and structure of a wiring are extracted from the layout data. FIG. 3A shows the layout data with LEF, and FIG. 3B shows the layout data with DEF, GDSII. FIG. 3C shows data (wiring data) concerning the connection and structure of the wiring obtained from the layout data. In the calculation of the inductance L, only the data concerning XYZ coordinate of start and end points of the wiring, wiring layers, wiring width, and thickness of the wiring may be obtained. Therefore, there is an advantage that an amount of data smaller than that in the calculation of resistance R and capacity C is necessary.

Next, the wiring is divided into the segments in the places such as the bend of the wiring, an intersection position, and the via (step S13).

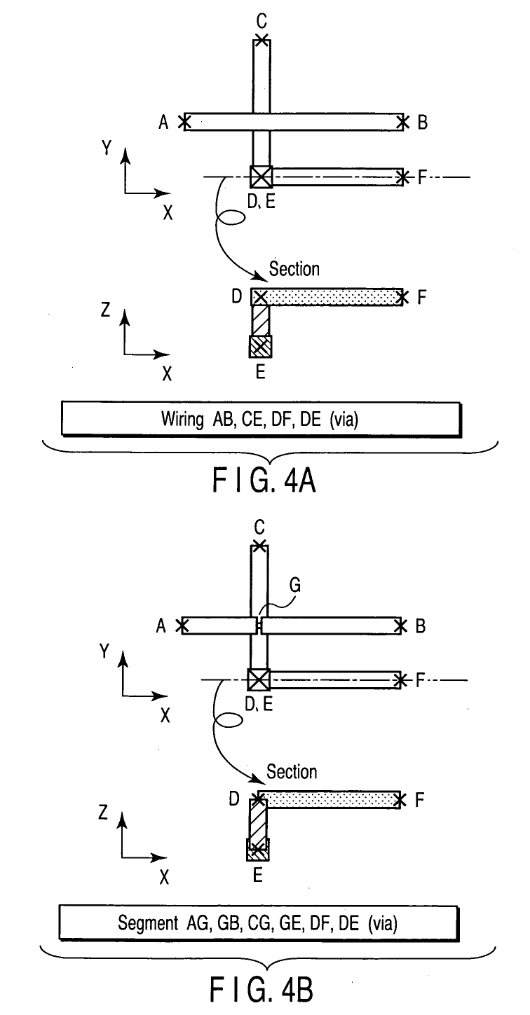

FIGS. 4A, 4B are explanatory views of a concrete example in which wiring data is divided into the segments. When there are wirings AB, CE, DF, DE (via) including a structure shown in FIG. 4A, and when the wirings are divided into the segments in dividing places such as the intersection of the wirings, the bend of the wiring, the via, and a designated wiring length, segments AG, GB, CG, GE, DF, DE (via) are obtained as shown in FIG. 4B.

Next, a relation between the segments (parallel/orthogonal/oblique, length, interval, and the like) is checked (step S14). Here, the lengths of the segments AG, GB, CG, GE, DF, DE (via) are obtained. Moreover, the relation among the respective segments AG, GB, CG, GE, DF, DE (via) is checked.

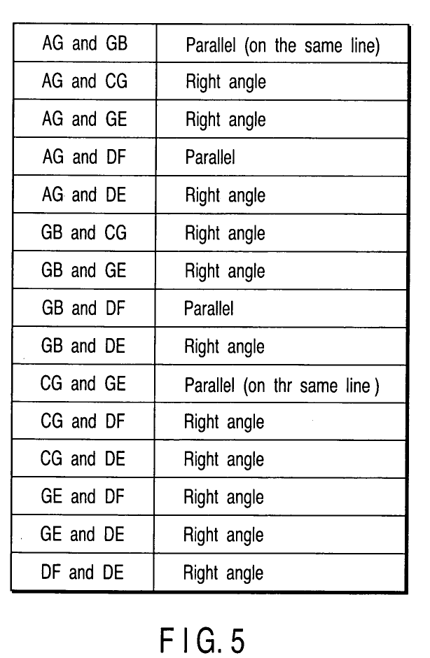

FIG. 5 is a diagram showing the relations between the segments with respect to the wiring structures shown in FIGS. 4A, 4B.

Next, the partial self inductance L of each segment and the partial mutual inductance M between the segments are extracted (step S15). Next, the extracted partial self inductance L and partial mutual inductance M are used in extracting a critical net, preparing an RLC circuit network, and calculating delay (step S16). For example, the method comprises: calculating the partial self inductance L and partial mutual inductance M; using a power supply wiring in which a current return path is dominant to calculate a loop inductance; calculating the delay from the resistance, loop inductance, and capacity; and searching the critical net influenced by the inductance. The method can further comprise: extracting the partial self inductance L and partial mutual inductance M; constituting the segment by a π-type or T-type equivalent circuit including the partial self inductance L and/or partial mutual inductance M, the resistance R, and the capacity C; removing a place in which the partial self inductance L or partial mutual inductance M is small; and performing a static or dynamic timing analysis.

FIG. 6 shows a flow indicating details for setting conditions in performing a step of extracting the connection and structure of the wiring from the layout data (step S12 of FIG. 2). First, the wiring of the whole region is performed (step S21). Next, it is judged whether or not the via is extracted. If YES, the flow advances to step S23. If NO, the wiring excluding the via is treated (step S22-1). Thereafter, the flow advances to the step S23.

It is judged in the step S23 whether or not the wiring as the object exceeds a maximum wiring length. IF YES, the flow advances to step S24. If NO, a step of removing short wirings is performed (step S23-1). Thereafter, the flow advances to the step S24.

It is judged in the step S24 whether or not the portion is in a range of region designation of an input file. If YES, the flow advances to step S25. If NO, a step of removing the portion outside the region is performed (step S24-1). Thereafter, the flow advances to the step S25.

It is judged in the step S25 whether or not a power supply/bus/clock wiring is regarded as the object. If YES, the flow advances to step S26. If NO, a step of removing the wirings other than the designated wirings is performed (step S25-1). Thereafter, the flow advances to step S26. In the step S26, the connection and structure of the wiring are extracted. It is to be noted that a ground wiring may also be included as the object of the condition setting.

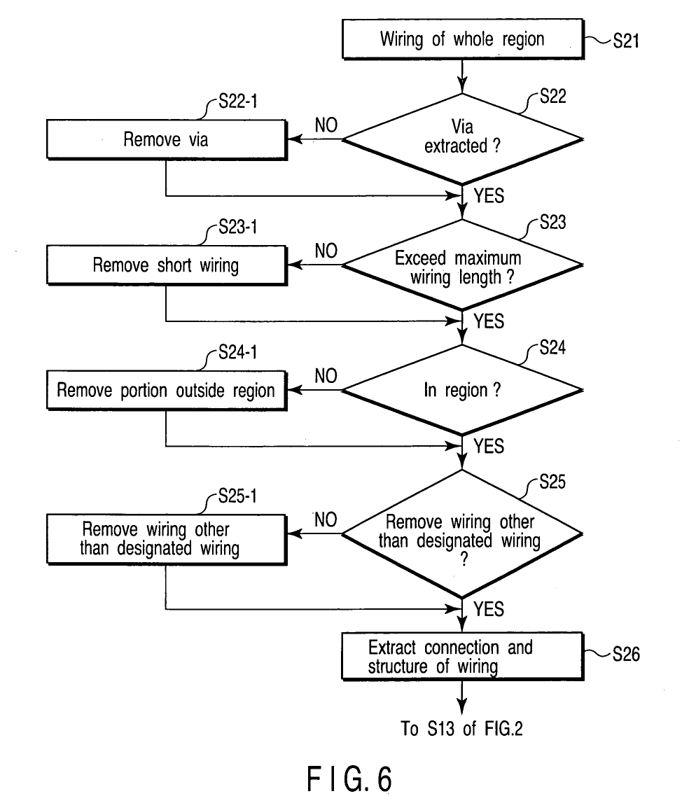

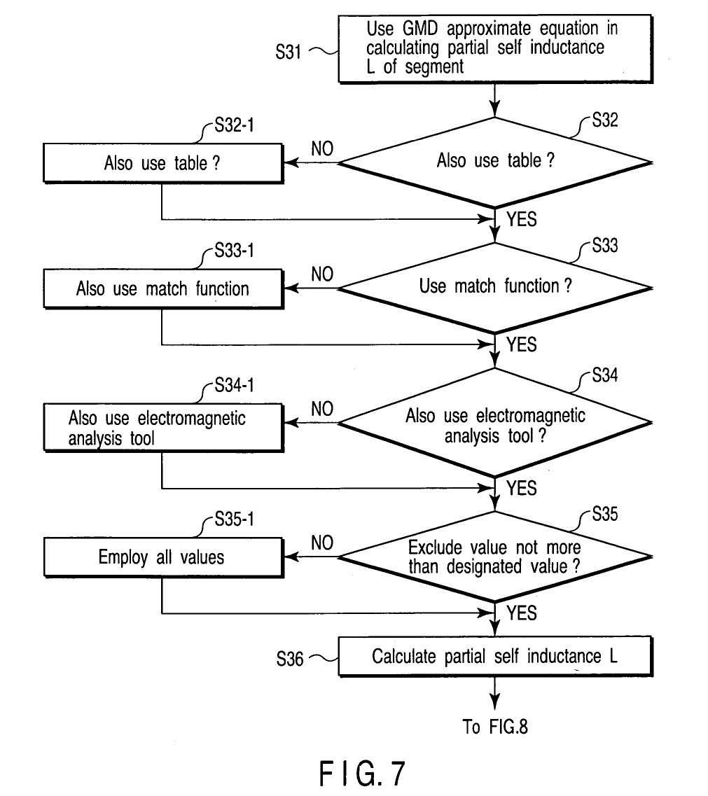

FIG. 7 shows a flow indicating details for setting the conditions in performing a step of extracting the partial self inductance of the segment (step S15 of FIG. 2). First, it is determined that an approximate equation of a geometric mean distance (GMD) of the wiring section be used in calculating the partial self inductance L of the segment (step S31). Next, it is judged whether or not a table is also used (step S32). If YES, the flow advances to step S33. If NO, it is determined that the table is also used (step S32-1). Thereafter, the flow advances to step S33. Here, when the wiring structure is largely influenced by the skin effect or proximity effect, the table of data obtained beforehand by the electromagnetic analysis tool is also used. Alternatively, a polynomial equation of the data obtained beforehand by the electromagnetic analysis tool may also be used.

It is judged in the step S33 whether or not a match function is to be used. If YES, the flow advances to step S34. If NO, it is determined that the match function is also used (step S33-1). Thereafter, the flow advances to the step S34.

It is judged in the step S34 whether or not the electromagnetic analysis tool is also used. If YES, the flow advances to step S35. If NO, it is determined that the electromagnetic analysis tool is also used (step S34-1). Thereafter, the flow advances to the step S35. Here, when the wiring structure is largely influenced by the skin effect or proximity effect, the electromagnetic analysis tool is also used.

It is judged in the step S35 whether or not a value not more than a designated value is excluded. If YES, the flow advances to step S36. If NO, all the values are determined to be employed (step S35-1). Thereafter, the flow advances to step S36.

In the step S36, the partial self inductance L is calculated. Thereafter, the flow advances to step S41 of FIG. 8.

FIG. 8 shows a flow indicating details for setting the conditions in performing a step of extracting the partial mutual inductance between the segments (step S15 of FIG. 2).

First, the use of the equation in calculating the partial mutual inductance M between the segments is determined (step S41). Next, it is judged whether or not the equation is selected in accordance with the wiring structure (step S42). If NO, the flow advances to step S43. If YES, the use of a map described later (FIG. 18) is determined (step S42-1). Thereafter, the flow advances to step S43.

It is judged in the step S43 whether or not the table is also used. If YES, the flow advances to step S44. If NO, it is determined that the table is also used (step S43-1). Thereafter, the flow advances to step S44.

It is judged in the step S44 whether or not the match function is also used. If YES, the flow advances to step S45. If NO, it is determined that the match function is also used (step S44-1). Thereafter, the flow advances to step S45.

It is judged in the step S45 whether or not the electromagnetic analysis tool is also used. If YES, the flow advances to step S46. If NO, it is determined that the electromagnetic analysis tool is also used (step S45-1). Thereafter, the flow advances to step S46.

It is judged in the step S46 whether or not the value not more than the designated value is excluded. If YES, the flow advances to step S47. If NO, all the values are determined to be employed (step S46-1). Thereafter, the flow advances to step S47.

In the step S47, the partial self inductance L is calculated. Thereafter, the flow advances to the step S16 of FIG. 2.

Next, a concrete calculating method using the equations of the partial self inductance L of the segment and the partial mutual inductance M between the segments will be described.

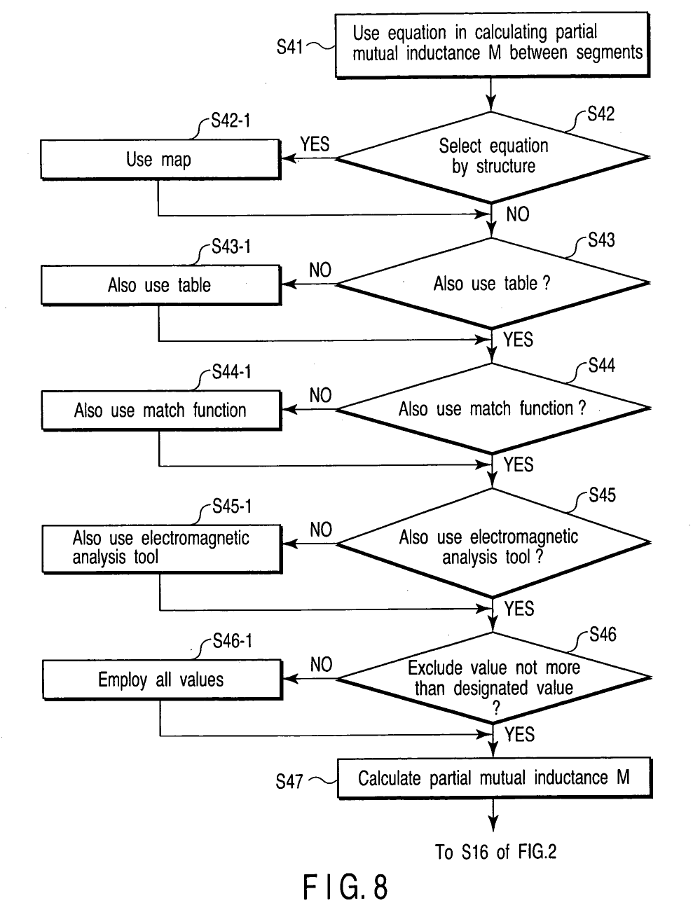

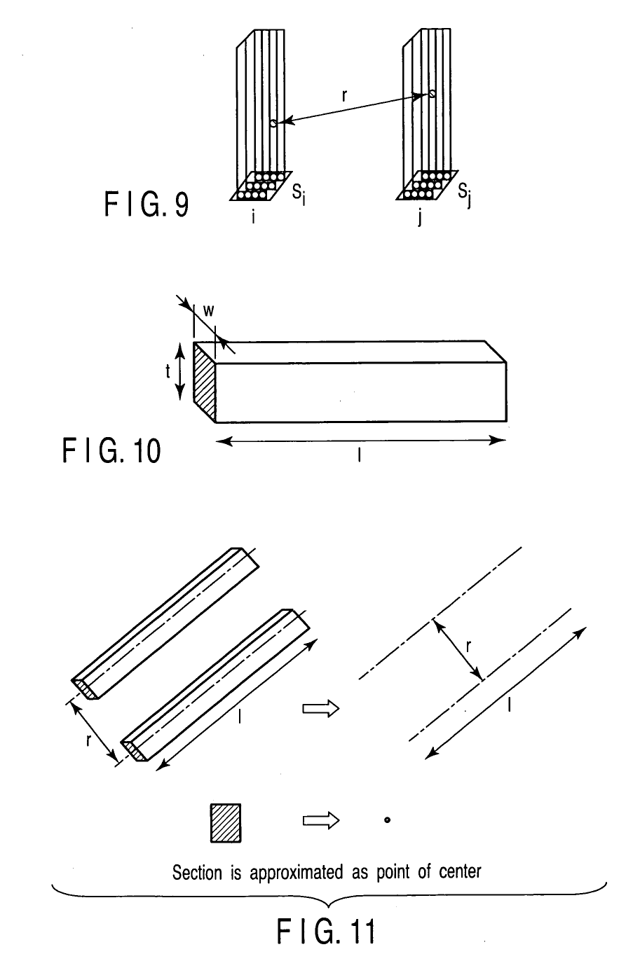

First, a calculating method for the inductance, which is performed with a conventional electromagnetic analysis tool, will be described. Here, as shown in FIG. 9, two wirings i, j which have sectional areas Sᵢ, Sⱼ are the objects of consideration. Then, a mutual inductance Mᵢⱼ between the two wirings i, j is regarded as a synthesized mutual inductance at a fine division time into linear conductors which have infinitely small sectional areas dSᵢ, dSⱼ.

On the other hand, a mutual inductance dmᵢⱼ between two closed circuits whose sections can be ignored is represented as follows from Neumann formula:

$${dM}_{ij} = \frac{μ}{4 π} {∮}_{i} {∮}_{j} \frac{1}{r} ⅆ {s}_{i} ⅆ {s}_{j} \qquad ( 1 )$$

The mutual inductance Mᵢⱼ in which the sectional areas Sᵢ, Sⱼ are considered is as follows:

$${M}_{ij} = \frac{1}{{S}_{i} {S}_{j}} {\int }_{{S}_{i}} ⅆ {S}_{i} {\int }_{{S}_{j}} ⅆ {S}_{j} \cdot \frac{μ}{4 π} {∮}_{i} {∮}_{j} \frac{1}{r} ⅆ {s}_{i} ⅆ {s}_{j} \qquad ( 2 )$$

When the Neumann formula is applied to two line segments l, m having a finite length, the mutual inductance M is as follows:

$$M = \frac{μ}{4 π} {\int }_{l} {\int }_{m} \frac{cos θ}{r} ⅆ {s}_{l} ⅆ {s}_{m} \qquad ( 3 )$$

The mutual inductance between two linear wirings can be derived. Additionally, θ denotes an angle formed by the line segments l, m. Since permeability μ is substantially equal to permeability μ₀ of vacuum in a nonmagnetic wiring or insulating film, μ₀ will be used hereinafter.

Next, the calculating method for the partial self inductance according to the present embodiment will be described. Here, the partial self inductance of one wiring which has a width w, thickness t, and length l as shown in FIG. 10 is obtained using the following approximate equation in which the geometric mean distance (GMD) is considered.

The self inductance L is obtained by the following equation:

$$L = \frac{{μ}_{0} l}{2 π} [ ln \frac{2 l}{w + t} + \frac{1}{2} + \frac{0.2235 ( w + t )}{l} ] \qquad ( 4 )$$

One conductor whose rectangular section has the width w and thickness t is divided into the linear wirings (filaments), and the equation is obtained from the GMD. Here, for GMD_{R}, R=k(w+t)=0.2235 (w+t) is used. Coefficient k denotes all combinations of the width w and thickness t, and has a relation of 0.22313≦k≦0.22369, and the following equation gives approximation high in accuracy:

k≅0.2235 (5)

Next, the calculating method for the partial mutual inductance according to the present embodiment will be described. Here, the linear wiring is assumed whose section is an infinitely small point. When two linear wirings are parallel to each other, an exact equation of parallel wirings between the linear conductors is used to calculate the partial mutual inductance with respect to the wirings within a designated interval. When the angle of two wirings is larger than 0 degree and smaller than 90 degrees, the partial mutual inductance is calculated with the exact equation of oblique wirings between the linear conductors. When two wirings form 90 degrees, the inductance is obtained assuming that the partial mutual inductance is 0.

The above-described respect will be described in detail. Here, two wirings (l is the length of the wiring, and r denotes a distance between the wirings) shown in FIG. 11 is the object of consideration. For the partial mutual inductance between the two wirings, the wiring section is approximated with the point of the center of the section, and a distance between the centers is used to use the exact equation between the linear conductors.

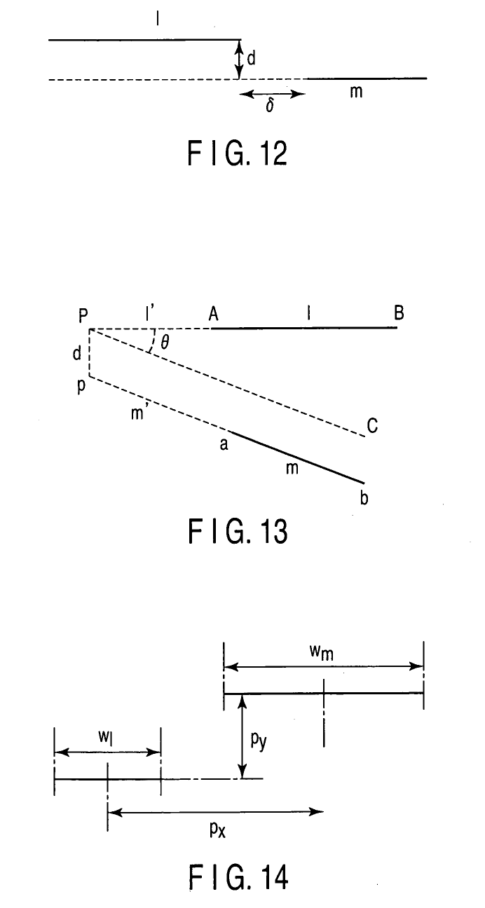

FIG. 12 shows that two wirings extend in parallel with each other. The partial mutual inductance M between the linear parallel wirings is as follows:

$$M = \frac{{μ}_{0}}{4 π} \{ α {sinh}^{- 1} \frac{α}{d} - \sqrt{{α}^{2} + {d}^{2}} - β {sinh}^{- 1} \frac{β}{d} + \sqrt{{β}^{2} + {d}^{2}} - {γsinh}^{- 1} \frac{γ}{d} + \sqrt{{γ}^{2} + {d}^{2}} + {δsinh}^{- 1} \frac{δ}{d} - \sqrt{{δ}^{2} + {d}^{2}} \} , \qquad ( 6 )$$

wherein α=l+m+δ, β=l+δ, γ=m+δ.

If l overlaps with m, a symbol of δ is negative.

If l=m and δ=−l, the inductance is obtained by the following equation:

$$M = \frac{{μ}_{0}}{2 π} \{ l {sinh}^{- 1} ( \frac{l}{d} ) - \sqrt{{l}^{2} + {d}^{2}} + d \}$$

When the wirings are on the same line (d=0), the inductance is obtained by the following equation:

$$M = \frac{{μ}_{0}}{4 π} \{ α ln α - β ln β - γ ln γ + δln δ \}$$

FIG. 13 shows that the angle of two wirings is larger than 0 degree and smaller than 90 degrees, that is, two wirings have a mutually oblique relation. d denotes a distance between a plane BPC and a parallel plane of a line segment ab. The distances from end points of line segments l, m are represented by Bb=R₁, Ba=R₂, Aa=R₃, Ab=R₄. The partial mutual inductance M of linear oblique wirings is obtained by the following equation:

$$M = \frac{{μ}_{0} cos θ}{2 π} \{ ( {l}^{′} + l ) {tanh}^{- 1} \frac{m}{{R}_{1} + {R}_{2}} + ( {m}^{′} + m ) {tanh}^{- 1} \frac{l}{{R}_{1} + {R}_{4}} - {l}^{′} {tanh}^{- 1} \frac{m}{{R}_{3} + {R}_{4}} - {m}^{′} {tanh}^{- 1} \frac{l}{{R}_{2} + {R}_{3}} - \frac{1}{2} \frac{Ω d}{sin θ} \} , \qquad ( 7 )$$

wherein,

$$cos θ = \frac{{α}^{2}}{2 l m} , {α}^{2} = {R}_{4}^{2} - {R}_{3}^{2} + {R}_{2}^{2} - {R}_{1}^{2} , \\ {l}^{′} = \frac{\{ 2 {m}^{2} ( {R}_{2}^{2} - {R}_{3}^{2} - {l}^{2} ) + {α}^{2} ( {R}_{4}^{2} - {R}_{3}^{2} - {m}^{2} ) \} l}{4 {l}^{2} {m}^{2} - {α}^{4}} , \\ {m}^{′} = \frac{\{ 2 {l}^{2} ( {R}_{4}^{2} - {R}_{3}^{2} - {m}^{2} ) + {α}^{2} ( {R}_{2}^{2} - {R}_{3}^{2} - {l}^{2} ) \} m}{4 {l}^{2} {m}^{2} - {α}^{4}} ,$$

R₁²=(l′,+l)²+(m′+m)²−2(l′+l)(m′+m)cosθ,

R₂²=(l′+l)²+m′²−2m′(l′+l)cosθ,

R₃²=l′²−2l′m′cosθ,

R₄²=l′²+(m′+m)²−2l′(m′+m)cosθ,

d²=R₃²−l′²−m′²+2l′m′cosθ,

$$Ω = {tan}^{- 1} \{ \frac{{d}^{2} cos θ + ( {l}^{′} + l ) ( {m}^{′} + m ) {sin}^{2} θ}{d {R}_{1} sin θ} \} - {tan}^{- 1} \{ \frac{{d}^{2} cos θ + ( {l}^{′} + l ) {m}^{′} {sin}^{2} θ}{d {R}^{2} sin θ} \} + {tan}^{- 1} \{ \frac{{d}^{2} cos θ + {l}^{′} {m}^{′} {sin}^{2} θ}{d {R}_{3} sin θ} \} - {tan}^{- 1} \{ \frac{{d}^{2} cos θ + {l}^{′} ( {m}^{′} + m ) {sin}^{2} θ}{d {R}_{4} sin θ} \}$$

When two wirings cross at right angles to each other, M=0.

Next, the approximate equation of the mutual inductance between the linear wirings having a parallel equal length will be described.

The exact equation of the mutual inductance between the linear wirings having the parallel equal length is represented by the following:

$${dM}_{l} = \frac{{μ}_{0} l}{2 π} ( ln ( \frac{l}{r} + \sqrt{1 + {( \frac{l}{r} )}^{2}} ) - \sqrt{1 + {( \frac{r}{l} )}^{2}} + \frac{r}{l} ) \qquad ( 8 )$$

When this is Taylor-developed, and when l>r, the following equation results.

$$dM = \frac{{μ}_{0} l}{2 π} ( ln ( \frac{2 l}{r} ) - 1 + \frac{r}{l} - \frac{1}{4} \frac{{r}^{2}}{{l}^{2}} + … ) \qquad ( 9 )$$

When l≦r, the following equation results.

$$dM = \frac{{μ}_{0} l}{2 π} ( \frac{1}{2} \cdot \frac{l}{r} - \frac{1}{24} \cdot \frac{{l}^{3}}{{r}^{3}} + … ) \qquad ( 10 )$$

Approximations of second, third, and fourth terms of the equation (9) are as follows:

$$\begin{matrix}dM ≅ \frac{{μ}_{0} l}{2 π} ( ln ( \frac{2 l}{r} ) - 1 ) & ( 11 ) \\ dM ≅ \frac{{μ}_{0} l}{2 π} ( ln ( \frac{2 l}{r} ) - 1 + \frac{r}{l} ) & ( 12 ) \\ dM ≅ \frac{{μ}_{0} l}{2 π} ( ln ( \frac{2 l}{r} ) - 1 + \frac{r}{l} - \frac{1}{4} \frac{{r}^{2}}{{l}^{2}} ) & ( 13 )\end{matrix}$$

The equations (11) and (12) are well known as simplified inductance equations. When a ratio of l/r increases, the equation becomes more exact.

Similarly, the approximations of the first and second terms of the equation (10) are as follows.

$$\begin{matrix}dM ≅ \frac{{μ}_{0} l}{2 π} ( \frac{1}{2} \cdot \frac{l}{r} ) & ( 14 ) \\ dM ≅ \frac{{μ}_{0} l}{2 π} ( \frac{1}{2} \cdot \frac{l}{r} - \frac{1}{24} \cdot \frac{{l}^{3}}{{r}^{3}} ) & ( 15 )\end{matrix}$$

The above (11) to (15) are equations obtained by approximating the exact equation between the linear wirings by Taylor expansion.

Additionally, the method of using the equation of the wiring having the section assumed as the linear wiring to calculate the inductance has a disadvantage that an error increases with a broad wiring. To solve the problem, the present applicant has developed a new approximate equation in which the thickness of the wiring section is 0 and the finite width is derived from the geometric mean distance (GMD). The approximate equation will be described hereinafter. The finite width is obtained by linearly bunching the linear wirings. A mean mutual inductance among all the linear wirings in each conductor represents the obtained approximate equation.

FIG. 14 is a diagram showing one example of the wiring whose section has a thickness of 0 and a finite width. wₗ and wₘ denote the widths of the respective wirings, Pₓ denotes a distance between the centers of the wirings in an x-direction, and p_{y} denotes a distance between the centers of the wirings in a y-direction. Here, assuming a function of the distance between the centers of the wirings is f(r), a mean function associated with the distance between the sections of the wirings having a thickness of 0 and the finite width is represented by the following equation:

$$f ( R ) = \frac{1}{{w}_{l} \cdot {w}_{m}} {\int }_{{α}_{21}}^{{α}^{22}} ⅆ {x}_{2} {\int }_{0}^{{w}_{l}} g ( r ) ⅆ {x}_{1} , \qquad \text{(15-1)}$$

wherein

$${α}_{11} = {p}_{x} - \frac{{w}_{l}}{2} - \frac{{w}_{m}}{2} , {α}_{12} = {p}_{x} - \frac{{w}_{1}}{2} + \frac{{w}_{2}}{2} , \\ {α}_{21} = {p}_{x} + \frac{{w}_{l}}{2} - \frac{{w}_{m}}{2} \text{and} {α}_{22} = {p}_{x} + \frac{{w}_{l}}{2} + \frac{{w}_{m}}{2} .$$

Considering the structure in which the wiring section has the thickness of 0 and the finite width, the above-described equations (11) to (15) are replaced with the following equations. That is, when l>r, the equations are replaced with the following equations:

$$\begin{matrix}M ≅ \frac{{μ}_{0} l}{2 π} ( ln ( 2 l ) - 1 - ln {R}_{1} ) & ( 16 ) \\ M ≅ \frac{{μ}_{0} l}{2 π} ( ln ( 2 l ) - 1 - ln {R}_{1} + \frac{{R}_{2}}{l} ) & ( 17 ) \\ M ≅ \frac{{μ}_{0} l}{2 π} ( ln ( 2 l ) - 1 - ln {R}_{1} + \frac{{R}_{2}}{l} - \frac{1}{4} \frac{{R}_{3}^{2}}{{l}^{2}} ) & ( 18 )\end{matrix}$$

When l≦r, the equations are replaced with the following equations:

$$\begin{matrix}M ≅ \frac{{μ}_{0} l}{2 π} ( \frac{1}{2} \cdot \frac{l}{{R}_{4}} ) & ( 19 ) \\ M ≅ \frac{{μ}_{0} l}{2 π} ( \frac{1}{2} \cdot \frac{l}{{R}_{4}} - \frac{1}{24} \cdot \frac{{l}^{3}}{{R}_{5}^{3}} ) & ( 20 )\end{matrix}$$

The above-described equations (16) to (20) are equations obtained by Taylor-developing the exact equation between the linear wirings, subsequently setting the thickness of the wiring section to 0, and deriving the finite width from the geometric mean distance.

Here, the mean of the naturalized logarithm of distance R1 is represented as follows:

$$\begin{matrix}ln {R}_{1} = - 1.5 + \frac{1}{{w}_{l} {w}_{m}} {\sum }_{i = 1}^{2} {\sum }_{j = 1}^{2} ( {( - 1 )}^{i + j} ( \frac{1}{4} ( {α}_{ij}^{2} - {p}_{y}^{2} ) ln ( {α}_{ij}^{2} + {p}_{y}^{2} ) + {α}_{ij} {p}_{y} {tan}^{- 1} \frac{{α}_{ij}}{{p}_{y}} ) ) & ( 21 ) \\ \text{If} {p}_{y} = 0 , & \\ ln {R}_{1} = - 1.5 + \frac{1}{2 {w}_{l} {w}_{m}} {\sum }_{i = 1}^{2} {\sum }_{j = 1}^{2} ( {( - 1 )}^{i + j} {α}_{ij}^{2} ln {α}_{ij} ) & ( 22 )\end{matrix}$$

The mean of a distance R2 is represented as follows:

$$\begin{matrix}{R}_{2} = \frac{1}{2 {w}_{l} {w}_{m}} {\sum }_{i}^{2} {\sum }_{j}^{2} ( {( - 1 )}^{i + j } ( \frac{1}{3} ( {α}_{i j}^{2} - 2 {p}_{y}^{2} ) \sqrt{{α}_{i j}^{2} + {p}_{y}^{2}} + \\ {α}_{i j} {p}_{y}^{2 } ln ( {α}_{i j} + \sqrt{{α}_{i j}^{2} + {p}_{y}^{2}} ) ) )\end{matrix} \qquad ( 23 )$$

If py=0, R₂=Pₓ (24)

A square mean of a distance R3 is represented by the following equation.

$${R}_{3}^{2} = {p}_{x}^{2} + {p}_{y}^{2} + \frac{1}{12} ( {w}_{1}^{2} + {w}_{2}^{2} ) \qquad ( 25 )$$

A distance R4 is represented as follows:

$$\frac{1}{{R}_{4}} = \frac{1}{{w}_{l} {w}_{m}} {\sum }_{i}^{2} {\sum }_{j}^{2} ( {( - 1 )}^{i + j } ( {α}_{i j} {sinh}^{- 1} ( \frac{{α}_{i j}}{{p}_{y}} ) - \sqrt{{α}_{i j}^{2} + {p}_{y}^{2}} ) ) \qquad ( 26 )$$

If py=0,

$$\frac{1}{{R}_{4}} = \frac{1}{{w}_{l} \cdot {w}_{m}} {\sum }_{i = 1}^{2} {\sum }_{j = 1}^{2} ( {( - 1 )}^{i + j } {α}_{i j} ln {α}_{i j} ) \qquad ( 27 )$$

Moreover, a cubic inverse mean of a distance R5 is represented as follows:

$$\frac{1}{{R}_{5}^{3}} = \frac{1}{{p}_{y}^{2}} \frac{1}{{w}_{l} {w}_{m}} {\sum }_{i}^{2} {\sum }_{j}^{2} ( {( - 1 )}^{i + j } ( \sqrt{{α}_{i j}^{2} + {p}_{y}^{2}} ) ) \qquad ( 28 )$$

If py=0,

$$\frac{1}{{R}_{5}^{3}} = \frac{1}{2 \cdot {w}_{1} \cdot {w}_{2}} {\sum }_{i = 1}^{2} {\sum }_{j = 1}^{2} ( {( - 1 )}^{i + j } \frac{1}{{α}_{i j}} ) \qquad ( 29 )$$

The equation of the mutual inductance in which the wiring section is exactly considered is represented by the following equation (30):

$$\begin{matrix}{M}_{b} = \frac{0.001}{abcd} [ [ [ ( \frac{{y}^{2} {z}^{2}}{4} - \frac{{y}^{4}}{24} - \frac{{z}^{4}}{24} ) x ln ( \frac{x + \sqrt{{x}^{2} + {y}^{2} + {z}^{2}}}{\sqrt{{y}^{2} + {z}^{2}}} ) + \\ ( \frac{{x}^{2} {z}^{2}}{4} - \frac{{x}^{4}}{24} - \frac{{z}^{4}}{24} ) y ln ( \frac{y + \sqrt{{y}^{2} + {z}^{2} + {x}^{2}}}{\sqrt{{z}^{2} + {x}^{2}}} ) + \\ ( \frac{{x}^{2} {y}^{2}}{4} - \frac{{x}^{4}}{24} - \frac{{y}^{4}}{24} ) z ln ( \frac{z + \sqrt{{z}^{2} + {x}^{2} + {y}^{2}}}{\sqrt{{x}^{2} + {y}^{2}}} ) + \\ \frac{1}{60} ( {x}^{4} + {y}^{4} + {z}^{4} - 3 {x}^{2} {y}^{2} - 3 {y}^{2} {z}^{2} - 3 {z}^{2} {x}^{2} ) \\ \sqrt{{x}^{2} + {y}^{2} + {z}^{2}} - \frac{x y {z}^{3}}{6} {Tan}^{- 1} \frac{x y}{z \sqrt{{x}^{2} + {y}^{2} + {z}^{2}}} - \\ \frac{x {y }^{3} z}{6} {Tan}^{- 1} \frac{x z}{y \sqrt{{x}^{2} + {y}^{2} + {z}^{2}}} - \frac{{x }^{3} y z}{6} {Tan}^{- 1} \frac{ y z}{z \sqrt{{x}^{2} + {y}^{2} + {z}^{2}}} ] \\ \begin{matrix}\begin{matrix}E - a , E + d \\ ( x )\end{matrix} \\ E + d - a , E\end{matrix} ] \begin{matrix}\begin{matrix}P - b , P + c \\ ( y )\end{matrix} \\ P + c - b , P\end{matrix} ] \begin{matrix}\begin{matrix}{l}_{3} - {l}_{1} , {l}_{3} + {l}_{2} \\ ( z )\end{matrix} \\ {l}_{3} + {l}_{2} - {l}_{2} , {l}_{3}\end{matrix} ] , wherein \\ [ [ [ f ( x , y , z ) ] \begin{matrix}\begin{matrix}{q}_{1} , {q}_{3} \\ ( x )\end{matrix} \\ {q}_{2} , {q}_{4}\end{matrix} ] \begin{matrix}\begin{matrix}{r}_{1} , {r}_{3} \\ ( y )\end{matrix} \\ {r}_{2} , {r}_{4}\end{matrix} ] \begin{matrix}\begin{matrix}{s}_{1} , {S}_{3} \\ ( z )\end{matrix} \\ {s}_{2} , {s}_{4}\end{matrix} ≡ \\ {\sum }_{i = 1}^{4} {\sum }_{j = 1}^{4} {\sum }_{k = 1}^{4} {( - 1 )}^{i + j + k + 1} f ( {q}_{i} , {r}_{j} , {s}_{k} ) .\end{matrix} \qquad ( 30 )$$

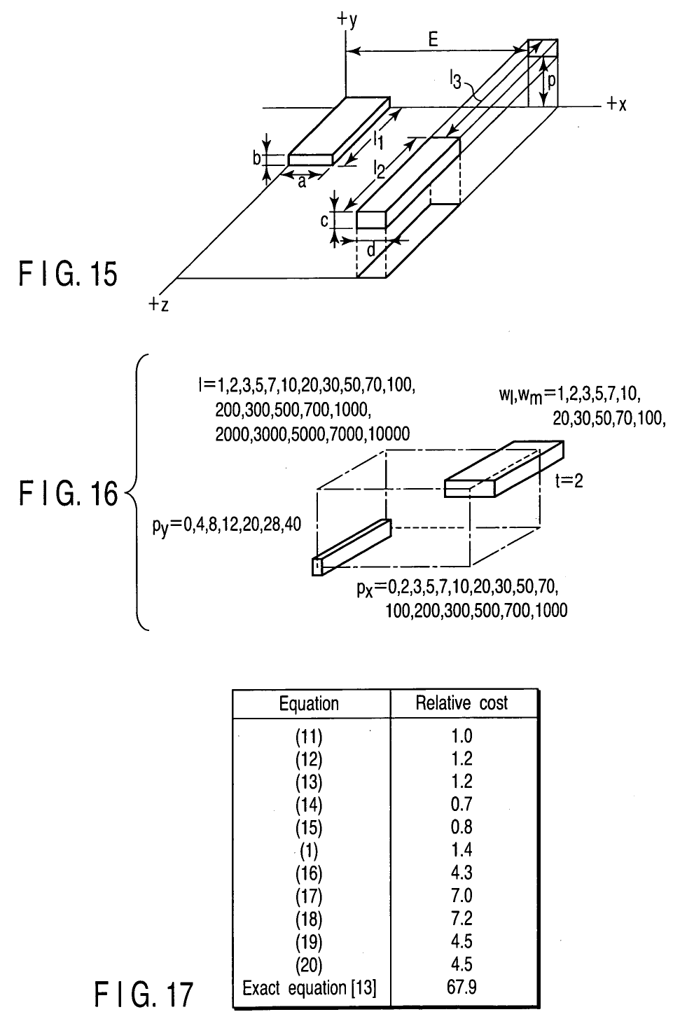

This equation represents a mutual inductance Mb between two parallel square bars, and FIG. 15 is a structure diagram.

The equation and structure diagram of the mutual inductance are disclosed in document Cletus Hoer and Carl Love, “Exact Inductance Equations for Rectangular Conductors With Applications to More Complicated Geometrics”, JOURNAL OF RESEARCH of the National Bureau of Standards-C. Engineering and Instrumentation Vl. 69C, No. 2, April-June 1965. The equation (30) corresponds to equation (14) in page 131 and an equation of a line starting with where in page 132 of the article. The structure diagram of FIG. 15 corresponds to FIG. 6 of page 132 of the article.

In the present embodiment, to calculate the mutual inductance between two wirings in a parallel relation, with respect to the wirings within a designated interval, the method comprises: comparing data with data obtained beforehand by the electromagnetic analysis tool (1) for each process or (2) using the conventional structure to select an equation whose error is within a predetermined range from the exact equation between the linear wirings (the above equation (8)), a plurality of equations (the above equations (11) to (15)) obtained by approximating the exact equation between the linear wirings with Taylor expansion, a plurality of equations (the above equations (16) to (20)) derived by applying the geometric mean distance to the wiring which is a bunch of a plurality of linear wirings and whose has the thickness of 0 and the finite width after the Taylor expansion of the exact equation between the linear wirings, and the equation (the above equation (30)) in which the wiring section is exactly considered, based on structure parameters of the width, interval, and length of the wiring. Next, an equation whose calculation cost is minimum from the selected equation is used to calculate the partial mutual inductance.

Here, in the conventional structure, at present and in future, the minimum width or the thickness of the wiring has substantially the following relation. Therefore, the structure which satisfies the relation is referred to as the conventional structure.

Wₘᵢₙ≅Sₘᵢₙ≅0.5t≅0.5hₘᵢₙ w≧Wₘᵢₙ, s≧sₘᵢₙ, h≧hₘᵢₙ (31)

wherein wₘᵢₙ denotes a minimum wiring width, sₘᵢₙ denotes a minimum interval, t denotes a wiring thickness, and hₘᵢₙ denotes an insulating film thickness between metal layers.

It is to be noted that the method (1) of finding the optimum equation by the structure by the above-described procedure for each process to use the equation for each process is higher in accuracy than the method (2) of finding the optimum equation by the structure in the conventional structure to use the equation for each process.

Moreover, in the calculation of the mutual inductance, in addition to the above-described equations, an equation in which only the wiring width or thickness is considered may also be used. In this case, for example, the equations (6), (8), (10) of the article are used.

In the following, a calculation result of the inductance using the above-described equations is compared with the calculation result of the partial inductance by the 3D field solver which is a three-dimensional electromagnetic analysis tool to verify the accuracy of the equations according to the present embodiment. Here, as shown in FIG. 16, the wiring structure including two conductors having the parallel equal length is verified. The number of combinations 50,000 or more.

1. First, the mutual inductance is obtained by the 3D field solver with respect to the structure.

2. Next, the above-described equations (8), (11), (12), (13), (14), (15), (16), (17), (18), (19), (20) are used to similarly obtain the mutual inductance of the wiring structure shown in FIG. 16. FIG. 17 is a table showing relative calculation costs of the respective equations (ratio of a processing time, when equation (11) is assumed as 1).

3. Next, the result obtained in 2. is compared with that obtained in 1. to find equations whose accuracy is within 3%.

4. Next, in the equations whose accuracy is within 3%, an equation whose calculation cost is minimum is found in the table shown in FIG. 17. FIG. 18 is a diagram showing the optimum equation obtained by this procedure by a map. That is, FIG. 18 is the map of the equation whose calculation cost is minimum in the equations whose accuracy is within 3%. The abscissa shows a ratio (w/r) of w to r, the ordinate denotes a ratio (r/l) of r to l, and the structure is defined by a coordinate position. When there are a plurality of equations having the accuracy of 3% or less, a simpler equation is selected. This map is useful, when a tradeoff of accuracy and calculation cost is considered and most efficient equation is selected in order to satisfy a threshold value of the demanded accuracy. Alternatives for using the respective equations in accordance with the structure are given to a user.

In FIG. 18, in a region denoted with Unmatch, even with the use of any of the equations (8), (11), (12), (13), (14), (15), (16), (17), (18), (19), (20), the accuracy is not within 3%. In this case, by the use of the exact equation in which the section is considered, that is, the equation (14) described in the above-described article, the accuracy can be set to 3% or less.

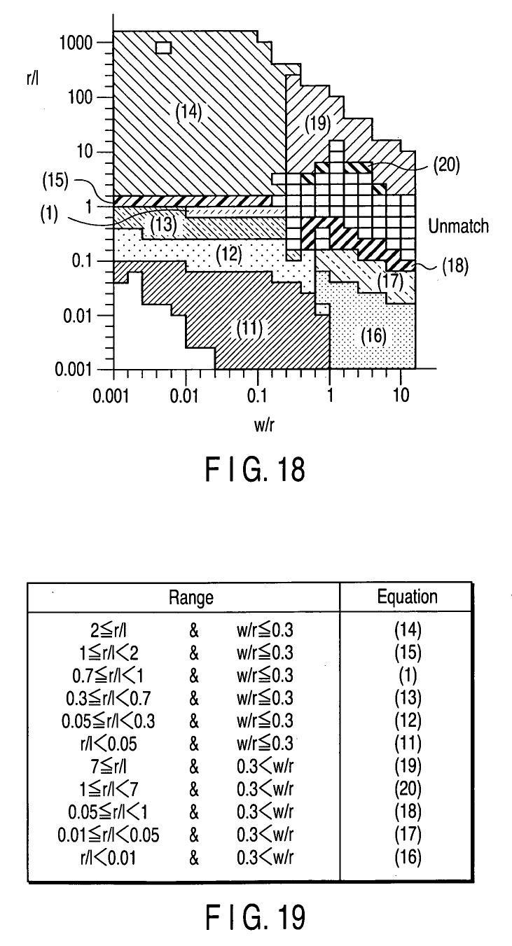

FIG. 19 is a diagram showing standards extracted from FIG. 18 by which the respective equations are approximately used by each structure.

It is to be noted that in the example the accuracy within 3% has been described, but the accuracy is arbitrary. For example, when the accuracy is set to 5% or less, an equation having a smaller calculation cost is further selected, and therefore the speed further increases.

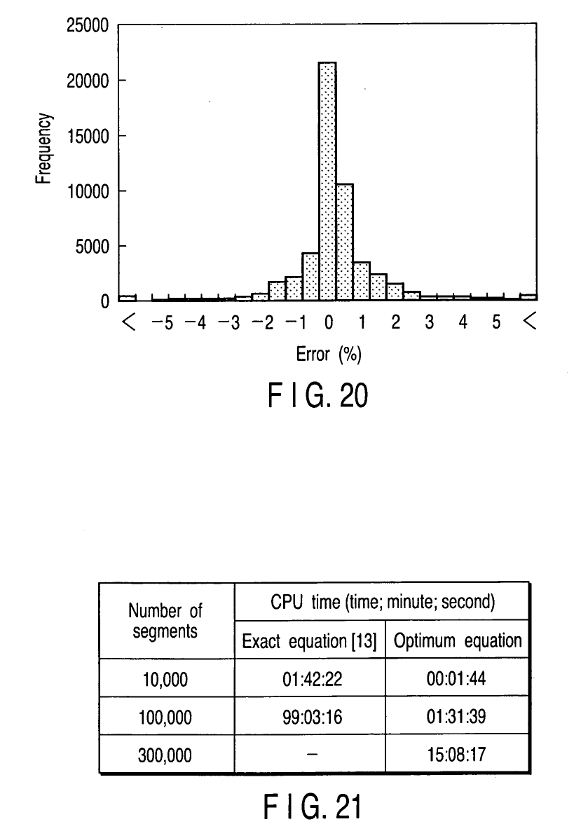

FIG. 20 shows an accuracy distribution, when the 3D field solver is assumed as the standard. The abscissa shows an error (%), and the ordinate shows a calculation frequency by the structure. As shown in FIG. 20, when the 3D field solver as the standard is used, and when the equation of the present application is used, the error is found to be in a range of 3% or less in many cases.

FIG. 21 is a diagram showing a result of comparison of an optimum equation by the structure shown in FIG. 18 and applied to an LSI wiring of an actual 0.13 μm process with the exact equation in which the section is considered with respect to the processing speed. As shown in FIG. 21, according to the present method, the high speed is about 60 times, and the mutual inductances of 300,000 segments can be calculated in about 15 hours. When the optimum equation suitable for the demanded accuracy is selected and used by the structure of the wiring, the inductance can be calculated at the high speed and with the high accuracy.

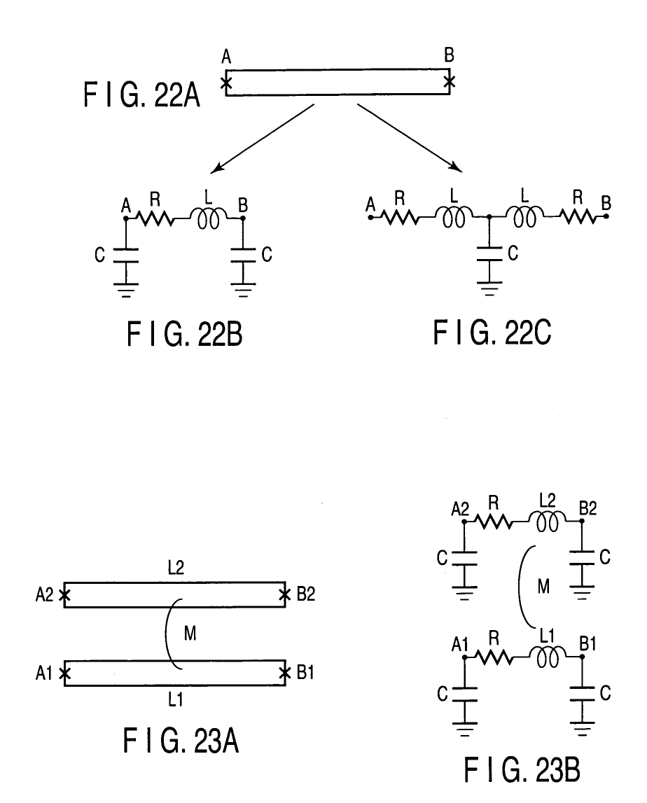

FIGS. 22A to 22C are explanatory views showing an application example in which the equivalent circuit is prepared in the step S16 based on the self inductance L extracted in the step S15 of FIG. 2. It is possible to constitute a π-type equivalent circuit shown in FIG. 22B or a T-type equivalent circuit shown in FIG. 21C by the self inductance L calculated with respect to one segment as shown in FIG. 22A and separately calculated resistance R and capacity C. The T-type equivalent circuit can be realized by equally dividing the segment into two in the step S15 of FIG. 2 and calculating the self inductance. However, since this circuit is higher in the calculation cost than the π-type equivalent circuit, the π-type equivalent circuit is more practical.

FIGS. 23A and 23B are diagrams showing an example in which the equivalent circuit is constituted based on the calculated mutual inductance M.

According to the present invention, the equations are used to calculate the inductance which is the wiring parasitic element of the large-scaled LSI, the practical accuracy is kept, and the high-speed processing time can be realized.

Moreover, since the optimum equation suitable for the demanded accuracy by the structure of the wiring is selected and used, the calculation of the inductance can be performed at the high speed and with the high accuracy.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A calculating method for an inductance in a semiconductor integrated circuit, comprising:
a step of recognizing connection of a wiring and structure of the wiring from a process structure and layout data of the wiring with respect to an object in a designated region;
a step of dividing the wiring into a plurality of segments based on predetermined places to be divided and designated wiring length with respect to the recognized connection and structure of the wiring;
a step of obtaining a relation between the divided two segments; and
a step of calculating partial self inductances of the respective segments based on the obtained relation between the two segments using an equation of a self inductance approximated with a geometric mean distance (GMD) of a wiring section and calculating a partial mutual inductance between the two segments using an equation of a mutual inductance.

2. The calculating method according to claim 1, wherein the step of calculating the partial mutual inductance comprises: regarding the wiring as a linear wiring whose section is infinitely small; calculating the partial mutual inductance with respect to the wiring within a designated interval using an equation of an exact parallel wiring between linear conductors, when two linear wirings are in a mutually parallel relation; calculating the partial mutual inductance using an exact equation of an oblique wiring between the linear conductors when an angle between two linear wirings is larger than 0 degree and smaller than 90 degrees; and setting the partial mutual inductance to 0 to obtain the inductance, when the two linear wirings form 90 degrees.

3. The calculating method for the inductance according to claim 1, wherein the step of calculating the partial mutual inductance comprises: regarding the wiring as a linear wiring whose section is infinitely small; comparing data with data obtained beforehand by an electromagnetic analysis tool for each process or using a conventional structure to select an equation whose error is within a predetermined range from an exact equation between the linear wirings, a plurality of equations obtained by approximating the exact equation between the linear wirings with Taylor expansion, a plurality of equations derived by applying a geometric mean distance to the wiring which is a bunch of a plurality of linear wirings and whose section has a thickness of 0 and a finite width after the Taylor expansion of the exact equation between the linear wirings, and an equation in which the wiring section is exactly considered with respect to the wiring within a designated interval, based on structure parameters of the width, interval, and length of the wiring, when two linear wirings have a mutually parallel relation; and next calculating the partial mutual inductance using an equation whose calculation cost is minimum from the selected equation.

4. The calculating method for the inductance according to claim 1, further comprising: also obtaining the partial self inductance and the partial mutual inductance using an electromagnetic analysis tool, when the wiring has a wiring structure largely influenced by a skin effect and a proximity effect.

5. The calculating method for the inductance according to claim 1, further comprises: obtaining a table of data obtained by an electromagnetic analysis tool beforehand and also obtaining the partial self inductance and the partial mutual inductance using the table, when the wiring has a wiring structure largely influenced by a skin effect and a proximity effect.

6. The calculating method for the inductance according to claim 1, further comprising: obtaining a polynomial equation of data obtained by an electromagnetic analysis tool beforehand and also obtaining the partial self inductance and the partial mutual inductance using the polynomial equation, when the wiring has a wiring structure largely influenced by a skin effect and a proximity effect.

7. The calculating method for the inductance according to claim 1, further comprises: obtaining the inductance using a power supply wiring and a ground wiring as objects whose inductances are calculated; and excluding the other wirings.

8. The calculating method for the inductance according to claim 1, further comprising: obtaining the inductance using a power supply wiring, a ground wiring, and a clock wiring, or a bus wiring as objects whose inductances are calculated; and excluding the other wirings.

9. The calculating method for the inductance according to claim 1, further comprising: obtaining the inductance using a power supply wiring, a ground wiring, and a signal wiring whose length is not less than a designated length as objects whose inductances are calculated; and excluding the other wirings.

10. The calculating method for the inductance according to claim 1, further comprising:
a step of calculating a loop inductance using a power supply wiring whose current return path is dominant; and
a step of calculating delay from a resistance, the loop inductance, and a capacity to search a critical net influenced by the inductance.

11. The calculating method for the inductance according to claim 1, further comprising:
a step of constituting the segment by a π-type or T-type equivalent circuit including the calculated partial self inductance and/or partial mutual inductance, a resistance, and a capacity; and
a step of removing a place whose partial self inductance or partial mutual inductance is small to perform a static or dynamic timing analysis.
